(19) United States
(12) Patent Application Publication
(10) Pub. No.: US 2007/0162166 A1
(43) Pub. Date: Jul. 12, 2007

(54) AUDIO PLAYING SYSTEM AND OPERATING METHOD THEREOF

(75) Inventors: Shyh-Jye Ni, Tainan City (TW); Chun-Yu Chiang, Kaohsiung City (TW); Chih-Yang Wang, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/620,098

(22) Filed: Jan. 5, 2007

(30) Foreign Application Priority Data
Jan. 5, 2006 (TW) 95100510

(51) Int. Cl. G06F 17/00

(52) U.S. Cl. 700/94

(57) ABSTRACT

An audio playing system and an audio playing method thereof. The audio playing system includes a storage unit, an audio playing unit, an identification unit and a control unit. The storage unit stores a first group of songs and a second group of songs. The audio playing unit analyzes and classifies the first group of songs and the second group of songs into a first kind of music and a second kind of music respectively. The control unit records a first number and a second number respectively representing the first group of songs and the second group of songs ever played by the current user. When the first number is more than the second number, and the identification unit later identifies the current user operates the audio playing system again, then the audio playing system will automatically play the first kind of music before the second kind of music.

This application claims the benefit of Taiwan application Serial No. 95100510, filed Jan. 5, 2006, the subject matter of which is incorporated herein by reference.

### BACKGROUND OF THE INVENTION

1. Field of the Invention

The invention relates in general to an audio playing system and an audio playing method thereof, and more particularly to an audio playing system and an audio playing method thereof capable of automatically playing user's favorite songs.

2. Description of the Related Art

With the progress of the technology, the capacity of a HDD (Hard Disk Driver) in an audio playing system is continuously increasing. One HDD may store hundreds to thousands of songs. Thus, more and more users store the songs in the HDD, and then choose the songs from the HDD instead of changing the CD (Compact Disc) in a CD player.

However, it is not easy to find user's favorite songs among hundreds to thousands of songs. In addition, the HDD has large capacity; the user usually has to spend a lot of time to find his/her favorite songs, thereby causing inconvenience in usage.

### SUMMARY OF THE INVENTION

It is therefore an object of the invention to provide an audio playing system and an audio playing method thereof capable of automatically playing user's favorite songs. The audio playing system automatically classifies the songs into different kinds of music and records each user's favorite kind of music. After being turned on, the audio playing system can play the favorite songs of one user. Compared with the prior art audio playing system, the user can conveniently use the current system without wasting a lot of time on choosing the songs.

The invention achieves the object above by providing an audio playing system including a storage unit, an audio playing unit, an identification unit and a control unit. The storage unit stores a first group of songs and second group of songs. The audio playing unit plays and analyzes the first group of songs and second group of songs into a first kind of music and a second kind of music respectively. The identification unit identifies a first user operating the audio playing system. The control unit records the first number and the second number respectively representing the first group of songs and the second group of songs ever played by the first user. When the first number is more than the second number, and the identification unit later identifies the first user operates the audio playing system again, then the audio playing system will automatically play the first kind of music before the second kind of music.

The invention also achieves the object above by providing an audio playing method used in an audio playing system. The audio playing method includes the following steps. First, First group of songs and a second group are stored to a storage unit of the audio playing system. Next, first group of songs and the second group of songs are analyzed and are classified into a first kind of music and a second kind of music respectively. Then, a first user is identified operating the audio playing system, and recording a first number and a second number respectively representing the first group of songs and the second group of songs ever played by the first user. Finally, when the first number is more than the second number, and identifying the first user operating the audio playing system again, the audio playing system will automatically play the first kind of music before the second kind of music

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing an audio playing system according to a preferred embodiment of the invention.

FIG. 2 is a schematic illustration showing a storage unit.

FIG. 3 is a schematic illustration showing sequences of a database.

FIG. 4 is a flow chart showing an audio playing method according to a preferred embodiment of the invention.

### DETAILED DESCRIPTION OF THE INVENTION

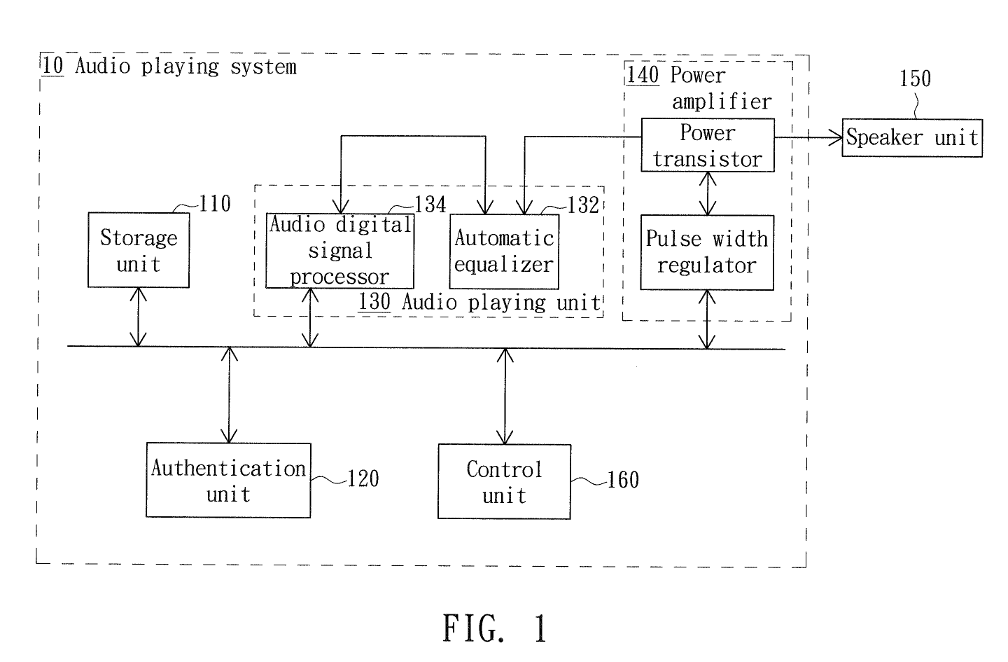

FIG. 1 is a block diagram showing an audio playing system 10 according to a preferred embodiment of the invention. Referring to FIG. 1, the audio playing system 10, such as a DVD-HTIB (Digital Video Disc Home Theater In Box), includes a storage unit 110, an identification unit 120, an audio playing unit 130, a power amplifier 140 and a control unit 160.

The storage unit 110, such as a HDD (Hard Disk Driver), stores songs and a database. The audio playing unit 130 analyzes and classifies songs into different kinds of music respectively. The control unit 160, such as a CPU (Central Processing Unit), controls the storage unit 110 to output the songs to the audio playing unit 130 and records a playing record to the database.

The identification unit 120 identifies a user according to, for example, a fingerprint of the user. The identification unit 120 may be disposed in, for example, a remote controller such that the user can be identified during the operation.

After the identification unit 120 has identified the user, the control unit 160 records the playing record of the songs ever played by the user to the database of the storage unit 110. The playing record may include, for example, what songs are listened at particular instants, the number of times of the same song to be played or what songs are cancelled before they are completely played.

For example, the storage unit 110 stores a first group of songs and second group of songs, and the audio playing unit 130 analyzes and classifies the first group and the second group of songs into a first kind of music and a second kind of music respectively. The identification unit 120 identifies a first user operating the audio playing system 10. The control unit 160 records the playing record to the database, and the playing record comprises a first number and a second number respectively representing the first group of songs and the second group of songs ever played by a first user. When the first number is more than the second number, and the identification unit 120 later identifies the first user operates the audio playing system 10 again, then the audio playing system 10 will automatically play the first kind of music before the second kind of music.

Furthermore, if the first number is more than the second number during one playing time interval, and the audio playing system 10 later identifies the first user operates the audio playing unit 130 again, then the audio playing system 10 will automatically play the first kind of music before the second kind of music in the playing time interval.

The playing record further comprises a third number and a fourth number respectively representing the first group of songs and the second group of songs ever played by a second user. When the third number is less than the fourth number, and the identification unit 120 later identifies the second user operates the audio playing system 10 again, then the audio playing system 10 will automatically play the second kind of music before the first kind of music.

In detail, the audio playing unit 130 includes an automatic equalizer 132 and an audio digital signal processor 134. The control unit 160 controls the storage unit 110 to output the songs to the audio digital signal processor 134. The audio digital signal processor 134 processes the songs by way of signal processing and then outputs the processed songs to the power amplifier 140, which feeds the processed songs back to the automatic equalizer 132. The automatic equalizer 132 generates the signal intensities of each of the songs in different frequency bands. The audio digital signal processor 134 analysis the signal intensities according to a look-up table which has reference signal intensities in different frequency bands so as to classify the songs into different kinds of music, such as lyric, blues, country, rock, jazz, and the like, automatically. The audio digital signal processor 134 generates a classifying record, which is stored to the database, according to the classified result of the songs.

For example, the signal intensities of the songs generated by the automatic equalizer 132 are listed in Table 1, and the look-up table in the audio digital signal processor 134 is listed in Table 2.

TABLE 1

| | Frequency (Hz) | | | | | | | | | |
|---|---|---|---|---|---|---|---|---|---|---|
| | 31 | 62 | 125 | 250 | 500 | 1K | 2K | 4K | 8K | 16K |
| Signal intensity (dB) of song | +1 | −3 | +5 | +7 | −2 | +4 | +6 | −8 | +10 | +1 |

TABLE 2

| | Frequency (Hz) | | | | | | | | | |
|---|---|---|---|---|---|---|---|---|---|---|
| | 31 | 62 | 125 | 250 | 500 | 1K | 2K | 4K | 8K | 16K |
| Reference signal intensity (dB) | +1 | −3 | +5 | +7 | −2 | +4 | +6 | −8 | +10 | +1 |
| of first kind of music | | | | | | | | | | |
| Reference signal intensity (dB) | +10 | −10 | +5 | +5 | −5 | +5 | +5 | −10 | +10 | +10 |
| of second kind of music | | | | | | | | | | |
| Reference signal intensity (dB) | +0 | −0 | +0 | +0 | −10 | +10 | +5 | −5 | +5 | +5 |
| of third kind of music | | | | | | | | | | |

The signal intensities of the songs can form a curve, and different kinds of music also can correspondingly form different curves. The audio digital signal processor 134 determines that the curve of the song approximates the curve of what kind of music by way of comparison according to, for example, mathematical analyzes (e.g., linear regression). When the curve of the song approximates the curve of the first kind of music, the song is judged as pertaining to the first kind of music.

In addition, when the similarity between the curves of the song and the kind of music does not have to reach 100%. For example, when the similarity between the curves of the song and the kind of music in the look-up table reaches 80%, the song can be judged as pertaining to this kind of music.

After the audio playing unit 130 has classified the songs in the storage unit 110 or the user stops classifying the songs and the user again operates the audio playing system 10, the audio playing unit 130 can automatically choose the user's favorite kind of music according to the previous playing record. The audio playing unit 130 can sequentially and automatically chooses to play each of the songs pertaining to this kind of music, or randomly and automatically choose to play each of the songs pertaining to this kind of music according to the previous playing record.

For example, the first kind of songs comprises a first song and a second song, the control unit 160 for records a fifth number and a sixth number respectively representing the first group of songs and the second group of song ever played by the first user, when the fifth number is more than the sixth number, and the identification unit 120 later identifies the first user operates the audio playing system 10 again, then the audio playing system 10 will automatically play the first song before the second songs.

The control unit 160 controls the storage unit 110 to output the chosen songs to the audio digital signal processor 134, which processes the chosen songs and outputs the processed songs to the power amplifier 140, which outputs and plays the processed songs. The power amplifier 140 may be, for example, a power amplifier of kind A, B, C or D, and a speaker unit 150 may be, for example, a 5.1 channel speaker.

In detail, the audio playing system 10 may operate in a pre-processing mode or a playing mode. When the audio playing system 10 operates in the pre-processing mode, the audio playing unit 130 automatically classifies the songs according to the signal intensities of the songs in different frequency bands, and stores the classifying record to the database.

When the audio playing system 10 operates in the playing mode, the audio playing system 10 identifies the user through the identification unit 120 and then stores the playing record of the current user to the database. If the same user again operates the audio playing system 10 in the playing mode, the audio playing unit 130 chooses the current user's favorite songs according to the playing record of the database.

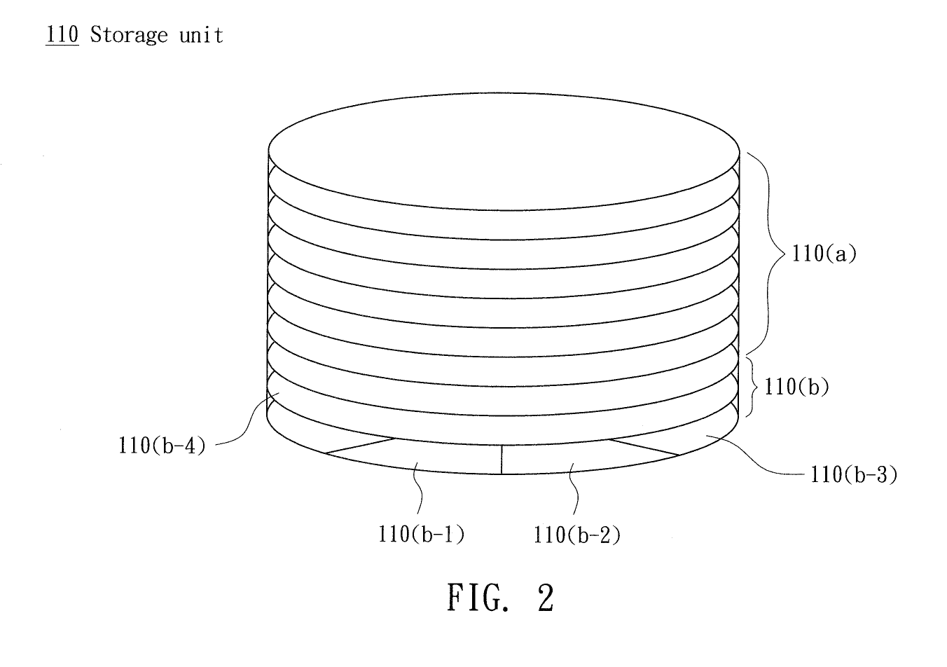

FIG. 2 is a schematic illustration showing a storage unit. As shown in FIG. 2, the storage region 110(a) of the storage unit 110 stores the songs, and the storage region 110(b) of the storage unit 110 stores the database, in which the classifying record and the playing record are stored in the database.

For example, the classifying record is stored to the storage region 110(b-4), and the storage region 110(b-1), the storage region 110(b-2) and the storage region 110(b-3) respectively store the playing records of the first to third users.

When the identification unit 120 identifies the current user, the current user's favorite songs are chosen according to the corresponding playing record in the database.

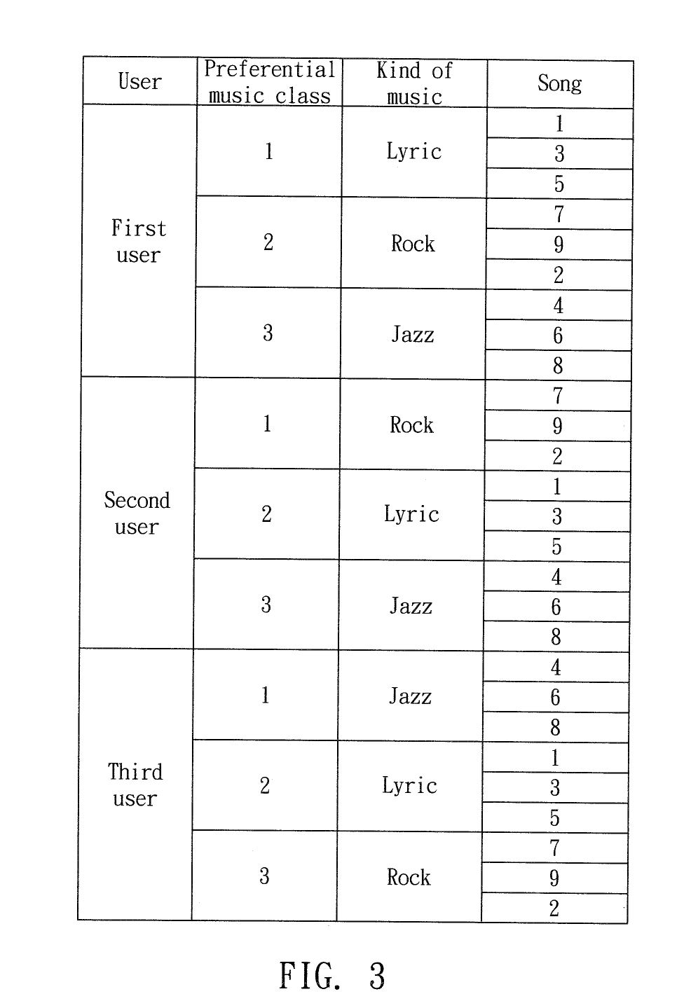

FIG. 3 is a schematic illustration showing sequences of a database. As shown in FIG. 3, the database of the storage unit 110 may be sorted according to each user's favorite kind of music and songs, and the current user's favorite kind of music may be quickly found after the audio playing system is turned on.

For example, when most of the songs chosen by the first user pertain to the lyric kind of music, the audio playing system 10 defines the lyric kind of music as the first preferential music class of the first user. In other words, when the number of times of playing the songs, which are chosen by the first user to play and pertains to the lyric kind of music, is the highest, the lyric kind of music is defined as the first preferential music class. When the same first user has been identified through the identification unit 120, the audio playing system 10 automatically plays the songs pertaining to the lyric kind of music.

In addition, when the second user is used to choose to play the songs pertaining to the rock kind of music in the morning, the audio playing system 10 defines the rock kind of music as the first preferential music class of the second user. When the same second user turns on the audio playing system 10 during the same playing time interval in the morning, the audio playing system 10 automatically plays each of the songs pertaining to the rock kind of music.

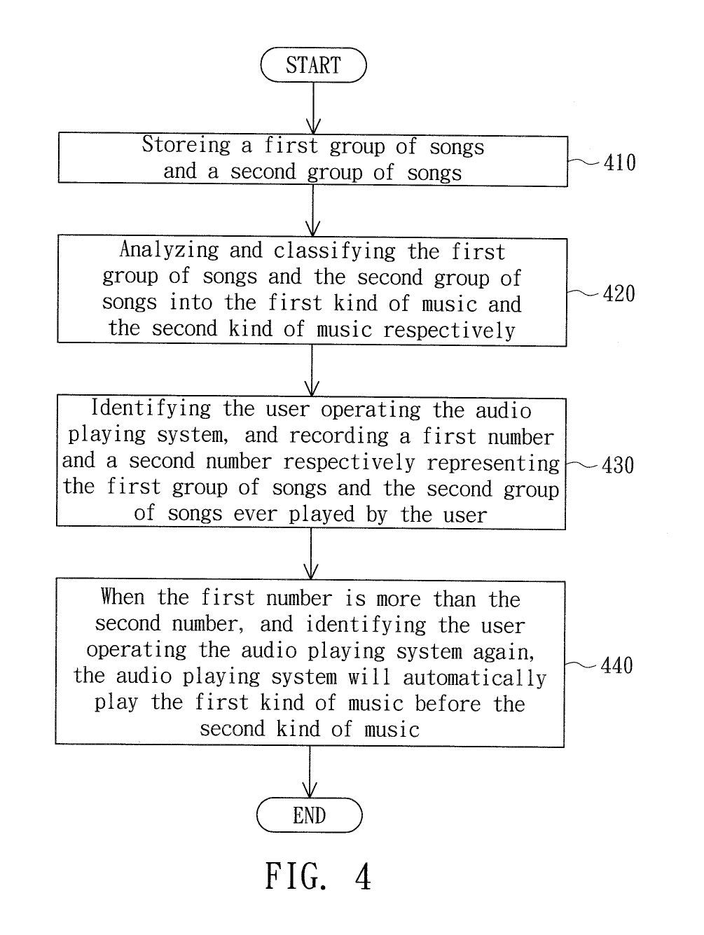

FIG. 4 is a flow chart showing an audio playing method according to a preferred embodiment of the invention. As shown in FIG. 4, the audio playing method is used in the audio playing system 10 and includes the following steps. First, in step 410, storage unit 110 stores a first group of songs and a second group of songs. Next, in step 420, the audio playing unit 130 analyzes and classifies the first group of songs and the second group of songs into the first kind of music and the second kind of music respectively. Then in step 430, the identification unit 120 identifies the user operating the audio playing system 10, and recording a first number and a second number respectively representing the first group of songs and the second group of songs ever played by the user. Finally, in step 440, when the first number is more than the second number, and the identification unit 120 identifies the user operating the audio playing system 10 again, the audio playing system 10 will automatically play the first kind of music before the second kind of music.

In the audio playing system and the audio playing method according to the embodiment of the invention, the songs are automatically classified into different kinds of music using the audio playing unit, and the playing record is stored to the database. When the identification unit identifies the current user, the user's favorite kind of music is automatically chosen and the songs pertaining to this kind of music are played. Thus, it is possible to prevent the user from wasting a lot of time to search for the to-be-played songs, thereby increasing the convenience in usage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio playing system, comprising:
a storage unit for storing a first group of songs and a second group of songs;
an audio playing unit for analyzing and classifying the first group of songs and the second group of songs into a first kind of music and a second kind of music respectively;
an identification unit for identifying a first user operating the audio playing system; and
a control unit for recording a first number and a second number respectively representing the first group of songs and the second group of songs ever played by the first user;
wherein when the first number is more than the second number, and the identification unit later identifies the first user operates the audio playing system again, then the audio playing system will automatically play the first kind of music before the second kind of music.

2. The audio playing system according to claim 1, wherein the audio playing unit comprises:
an automatic equalizer for generating a plurality of signal intensities of each of the songs in a plurality of frequency bands; and
an audio digital signal processor for analyzing the signal intensities to automatically classify the first group and the second group of songs into a first kind of music and a second kind of music respectively.

3. The audio playing system according to claim 2, wherein the audio digital signal processor analyzes the signal intensities, automatically classifies the first group of songs and the second group of songs into the first kind of music and the second kind of music respectively according to a look-up table which comprises a plurality of reference signal intensities in the frequency bands of the first kind of music and the second kind of music, and generates a classifying record according to a classified result of the songs.

4. The audio playing system according to claim 3, wherein the storage unit further stores a database, the control unit records the first number, the second number and the classifying record to the database.

5. The audio playing system according to claim 4, wherein the identification unit further identifies a second user operating the audio playing system, the control unit records a third number and a fourth number respectively representing the first group of songs and the second group of songs ever played by the second user, when the third number is less than the fourth number, and the audio playing system later identifies the second user operates the audio playing unit again, then the audio playing system will automatically play the second kind of songs before the first kind of songs.

6. The audio playing system according to claim 5, wherein the control unit records the third number and the fourth number to the database.

7. The audio playing system according to claim 1, wherein the first number is more than the second number during one playing time interval, and the audio playing system later identifies the first user operates the audio playing unit again, then the audio playing system will automatically play the first kind of music before the second music of songs in the playing time interval.

8. The audio playing system according to claim 1, wherein the identification unit automatically identifies the first user according to a fingerprint of the first user.

9. The audio playing system according to claim 8, wherein the identification unit is disposed in a remote controller.

10. The audio playing system according to claim 1, wherein the audio playing system correspondingly and randomly plays the first kind of songs.

11. The audio playing system according to claim 1, wherein the first kind of songs comprises a first song and a second song, the control unit for recording a fifth number and a sixth number respectively representing the first group of the songs and the second group of the songs ever played by the first user, when the fifth number is more than the sixth number, and the audio playing system later identifies the first user operates the audio playing unit again, then the audio playing system will automatically play the first song before the second songs.

12. A audio playing method used in a audio playing system, which comprises a storage unit, the audio playing method comprising the steps of:
storing a first group of songs and a second group of songs to the storage unit;
analyzing and classifying the first group of songs and the second group of songs into a first kind of music and a second kind of music respectively;
identifying a first user operating the audio playing system, and recording a first number and a second number respectively representing the first group of songs and the second group of songs ever played by the first user;
when the first number is more than the second number, and identifying the first user operating the audio playing system again, the audio playing system will automatically play the first kind of music before the second kind of music.

13. The method according to claim 12, wherein the step of analyzing and classifying comprises:
generating a plurality of signal intensities of each of the songs in a plurality of frequency bands; and
analyzing the signal intensities to automatically classify the first group of the song and the second group of songs into the first kind of music and a second kind of music respectively.

14. The method according to claim 13, wherein the first group of songs and the second group of songs are analyzed and classified into a first kind of music and a second kind of music respectively according to the signal intensities and a look-up table which comprises a plurality of reference signal intensities of the first kind of music and the second kind of music, and generates a classifying record according to a classified result of the songs.

15. The method according to claim 13, wherein the storage unit further stores a database, the first number, the second number and the classifying recorder are recorded to the database.

16. The method according to claim 12, wherein the first number is more than the second number during one playing time interval, and the audio playing system later identifies the first user operates the audio playing unit again, then the audio playing system will automatically play the first kind of music before the second kind of music in the playing time interval.

17. The method according to claim 12, further comprises the steps of:
identifying a second user operating the audio playing system, and recording a third number and a fourth number respectively representing the first group of songs and the second group of songs ever played by the second user;
when the third number is less than the fourth number, and identifying the second user operating the audio playing system again, the audio playing system will automatically play the second kind of music before the first kind of music.

18. The method according to claim 12, wherein the first group of songs comprises a first song and a second song, a fifth number and a sixth number respectively representing the first song and the second songs ever played by the first user, when the fifth number is more than the sixth number, and the audio playing system later identifies the first user operates the audio playing unit again, then the audio playing system will automatically play the first song before the second songs.

19. The method according to claim 12, wherein the audio playing system correspondingly and randomly plays the first kind of music.

20. The method according to claim 12, wherein identifying the first user operating the audio playing system according to a fingerprint of the first user
